(19) United States
(12) Patent Application Publication
(10) Pub. No.: US 2006/0066468 A1
(43) Pub. Date: Mar. 30, 2006

(54) Radar detection helmet visor

(76) Inventor: Henry V. Iszley, Lakewood, WA (US)

Correspondence Address: BLACK LOWE & GRAHAM, PLLC, 701 FIFTH AVENUE, SUITE 4800, SEATTLE, WA, 98104, US

(21) Appl. No.: 11/238,699

(22) Filed: Sep. 29, 2005

Related U.S. Application Data
(60) Provisional application No. 60/614,438, filed on Sep. 29, 2004.

(51) Int. Cl. G01S 7/40

(52) U.S. Cl. 342/20

(57) ABSTRACT

A radar detection device, radar detection device container, and a method includes a housing configured to attach to a motorcycle helmet to shield eyes of a motorcycle helmet wearer from overhead sunshine. The housing defines a void configured to house a radar detection circuit. The circuit is configured to reside in the void and includes an antenna. The antenna is configured to receive an electromagnetic signal. The electromagnetic signal is one of the group consisting of radar signals having wavelengths in the X-band, K-band and Ka-Band and lidar signals and to generate an operative signal based upon receipt of the electromagnetic signal. A processor is configured to receive the operative signal from the antenna according to the electromagnetic signal received at the antenna.

### FIELD OF THE INVENTION

The field of invention relates to radar detector apparatus, and more particularly pertains to a radar detection helmet visor.

### BACKGROUND OF THE INVENTION

Radar is still the most popular form of speed detection—some 100,000 guns are in use, and roughly 20,000 new ones are sold each year. A radar gun works by transmitting a microwave beam at the vehicle from which a speed is to be determined. When that beam reflects off the moving vehicle, the microwave beam changes is frequency due to Doppler shifting, and the reflected frequency is used to calculate speed.

Traffic radar, which is regulated by the Federal Communications Commission (FCC), operates on three frequency ranges. The oldest is X-band, from 10.500 to 10.550 gigahertz (GHz); about 10 percent of all radar guns use this band. The most popular radar representing about 60 percent of guns, operates on K-band, at 24.050 to 24.250 GHz. Increasingly popular is Ka-band, which spans a wide range of frequencies from 33.400 to 36.000 GHz; Ka-band accounts for 30 percent, including photo-radar units.

When used to detect the speed of a traveling motorcycle, fewer surfaces are suitably configured to reflect the microwave beam back to the detector so that the shift of frequency can be detected. The largest surface configured for return of such beams is the helmet area on most motorcycles that do not have fairings. Even in the presence of fairings, the motorcycle helmet is well-positioned to reflect a beam back to the radar gun.

Radar detecting superheterodyne units are known for use in a vehicle to detect the presence of radar signals in the X-band, K-band, Ka-band, and laser ranging signals. Many of the known radar-detecting units are compact and can either be permanently mounted in a vehicle or removably mounted. Recent improvements in microelectronic circuitry have enabled many of the known radar detectors to undergo a considerable size reduction, often with a corresponding lowering of the energy consumed by the circuitry.

When a radar detector is placed on a motorcycle, ambient noise will often drown out any detection enunciator and the task of driving will not allow for effective monitoring of a visual indicator, the positioning of the radar detector traditionally being in the proximity of handlebars on the radar detector. For this reason, conventional radar detectors configured for use in an automobile or truck have not gained acceptance among motorcycle ridership.

Radar detection helmets of various types have been designed to get past the shortcomings involving the use of a conventional radar detector on a motorcycle. One such detection helmet is that set forth in U.S. Pat. No. 4,719,462. Unfortunately, the radar detection helmet will not allow movement of the detection mechanism from one helmet to another helmet. Thus, where either of the helmet system or the detector system fail, the whole of the unit must be replaced. For this reason, there is an unmet need in the art for a helmet mounted radar detector.

### SUMMARY OF THE INVENTION

A radar detection device, radar detection device container, and a method includes a housing configured to attach to a motorcycle helmet to shield eyes of a motorcycle helmet wearer from overhead sunshine. The housing defines a void configured to house a radar detection circuit. The circuit is configured to reside in the void and includes an antenna. The antenna is configured to receive an electromagnetic signal. The electromagnetic signal is one of the group consisting of radar signals having wavelengths in the X-band, K-band and Ka-Band and lidar signals and to generate an operative signal based upon receipt of the electromagnetic signal. A processor is configured to receive the operative signal from the antenna according to the electromagnetic signal received at the antenna.

The invention provides an integrated compact visor, detachable from the helmet that will also function as a radar detector. The inventive visor may advantageously include detection for laser speed detectors.

The present invention comprises for installation on any helmet. In one presently preferred embodiment, the visor is readily detachable and re-attachable to suitably prepared helmets.

In accordance with further aspects of the invention, a communications system such as a CB or a Family Band walkie-talkie is incorporated in the design. Even such additional means may be possible as to allow for limited broadcast IR or low power FM two-way radio communication equipment may readily be included in the visor.

In accordance with other aspects of the invention, the visor may further include a receiver for broadcast programming such as AM/FM/Weather band transmissions.

In accordance with still further aspects of the invention, a GPS system may be suitably included in the visor. Additionally, a timer and clock function are advantageously included either for synchronization to the GPS signal or as stand-alone functions. Audio enunciators for “off-route” “on route” “next turn” or other suitable functions may be included. Visual enunciators may be used for “off-route” “on route” “next turn” or other suitable functions as well as functions suitable to the radar detection function. A screen may be provided for either on-head or off-head use depending upon user preference or safety concerns. Ambient light sensing means may be included to allow suitable attenuation of visual enunciators and screens to prevent distraction from the driving task.

In accordance with yet other aspects of the invention, a photoelectric cell may be suitably configured on the top aspect of the visor allowing recharging of batteries used to power the radar detection and other electronics. Small turbines allow for charging harvesting energy from the airflow around the visor. Batteries may be suitably mounted on the rear of the helmet to balance the weight of the visor.

In accordance with still another aspect of the invention, suitably the visor may include a visual enunciator in wireless connection to the visor to be placed on handlebars or on a windshield of the motorcycle.

In accordance with still further aspects of the invention, detection functionality may be placed in the visor for optimum reception and then by means of wireless communication with a logical processor mounted on the motorcycle, the heavier components of the detector circuitry may be borne by the frame of the motorcycle or on the handlebars.

### BRIEF DESCRIPTION OF THE DRAWINGS

Preferred and alternative embodiments of the present invention are described in detail below with reference to the following drawings.

FIG. 1 is a block diagram of a radar detection device visor.

FIG. 2a is a top view of the radar detection device visor;

FIG. 2b is a bottom view of the radar detection device visor;

FIG. 2c is a front view of the radar detection device visor;

FIG. 3 is a perspective view of the radar detection device visor from the lower right;

FIG. 4 is a side view of the radar detection device visor when mounted on a generic motorcycle helmet; and

FIG. 5 is a perspective view of the radar detector visor when mounted on a generic motorcycle helmet from the lower right.

### DETAILED DESCRIPTION OF THE PREFERRED EMBODIMENT

A radar detection device, radar detection device container, and a method includes a housing configured to attach to a motorcycle helmet to shield eyes of a motorcycle helmet wearer from overhead sunshine. The housing defines a void configured to house a radar detection circuit. The circuit is configured to reside in the void and includes an antenna. The antenna is configured to receive an electromagnetic signal. The electromagnetic signal is one of the group consisting of radar signals having wavelengths in the X-band, K-band and Ka-Band and lidar signals and to generate an operative signal based upon receipt of the electromagnetic signal. A processor is configured to receive the operative signal from the antenna according to the electromagnetic signal received at the antenna.

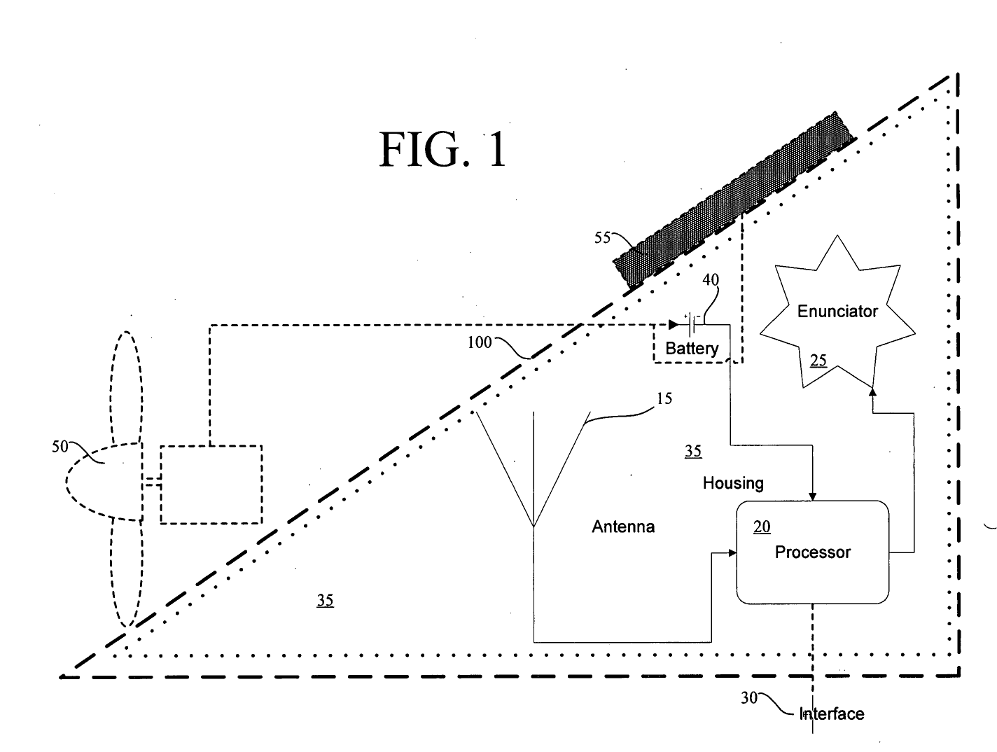

Referring to FIG. 1, a radar detection device visor includes a housing 10 configured to attach to a motorcycle helmet to shield eyes of a motorcycle helmet wearer from overhead sunshine and defining a void. The housing 10 may be advantageously constructed of a radio transparent plastic thereby assuring the optimal reception of signals at an antenna 15 the housing contains. The housing is configured for two purposes, to act as a visor and to suitably and operably contain electronic radar detection circuit 35 used to detect radar signals. The electronic radar detection circuit 35 includes the antenna 15 as well as a processor 20 and an enunciator 25. While a preferred embodiment includes the electronic radar detection circuit 35 designed specifically to reside in the housing 10 another embodiment includes a housing 10 configured to receive a commercially available off-the-shelf electronic radar detection circuit 35 including the antenna 15, the processor 20, the enunciator 25 and optionally an interface 30.

The radar detection circuit 35 is configured to reside in the void the bounding defines and includes the antenna 15 which is configured to receive an electromagnetic signal. The electromagnetic signal may be any of a group consisting of radar signals having wavelengths in the X-band, K-band and Ka-Band and lidar signals. The antenna 15 is also configured to generate an operative signal based upon receipt of the electromagnetic signal. The operative signal alerts the processor 20 to the presence of the electromagnetic signal.

The processor 20 is configured to receive the operative signal from the antenna 15 according to the electromagnetic signal received at the antenna 15. The processor 20, by known means such as by digital signal processing, determines the presence of the electromagnetic signal and further determines if such a signal is indicative of a radar or lidar used for detecting vehicle speed. If the processor 20 determines that a radar or lidar signal is present, the processor 20 triggers the enunciator 25 to suitably alert the user that such radar or lidar signal is present.

The enunciator 25 might be any sort of enunciator such as a buzzer or a flashing LED. Any enunciator 25 suitably to alert the user of the system as to the presence of the radar or lidar signal is suitable as the enunciator 25. In an embodiment, the enunciator are a plurality of enunciators configured to further alert the user as to the nature of the detected radar or lidar. A series of labeled LEDs, having labels indicative of the signal suitably serve the object of identifying the radar or lidar signal that caused the processor 20 to generate the warning signal.

An interface 30 optionally allows the wearer of the motorcycle helmet to suitably control the electronic radar detection circuit 35 including the processor 20 and the enunciator 25.

While nothing in this application requires that the current source be contained within the housing 10, an optional battery 40 is shown within the housing 10. The battery 10 is configured to power the electronic radar detection circuit 35. Additionally, either of a solar cell 55 or a wind turbine 50 may be used to charge and to extend the charged life of the battery 40.

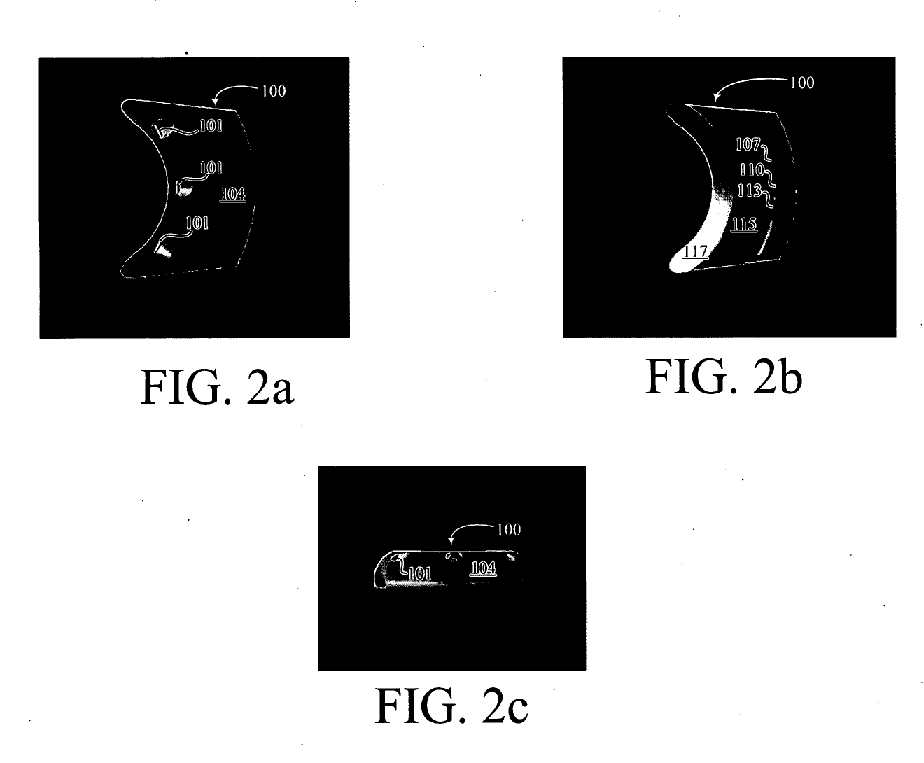

Referring to FIG. 2a, a top view of the radar detection device visor resident on a motorcycle helmet reveals a plurality of recesses 101 the upper surface 104 of the housing 100. The recesses 101 are suitably configured to receive a component of a fastener such as, by way of nonlimiting example, a snap fastener to attach the housing 100 to a motorcycle helmet. Screws, cam locks, and other such fasteners will also allow detachable attachment the motorcycle helmet. More permanent bonding by adhesive, resin, or rivets will also suitably serve to attach the housing 100 to the motorcycle helmet.

Advantageously, the upper surface 104 is suitably configured to include at least a radio-transparent pane for admitting electromagnetic signals to the antenna 15 (FIG. 1). The material for forming the upper surface 104 is selected for suitable radio transparency.

Referring to FIG. 2b, a bottom view of the radar detection device visor resident on a motorcycle helmet depicts a mounting surface 117 configured to conform to a surface of a motorcycle helmet. Additionally shown is a recess 115 the bottom surface defines to allow mounting of enunciator LEDs, 107, 111, and 113 substantially orthogonal to a user's line of sight for ease of focus and ability to discern without forcing the eyes to move a great distance from the roadway. In one embodiment, optical lenses provide further assistance by allowing the user to focus on the enunciator LEDs, 107, 111, and 113 using far-vision similar to the focus on the road surface ahead of the motorcycle thereby obviating the need to refocus as the eye shifts from the road surface to the enunciator LEDs, 107, 111, and 113 and back.

Referring to FIG. 2c a front view of the radar detection device visor shows the canted upper surface 104 of the housing 100 and the recesses 101 and demonstrates the configuration to allow a relatively large pane for exposure of the antenna 15 to allow for optimal detection of electromagnetic signals along the line of travel. Advantageously, the housing 100 providing a narrow presentation to wind as the housing 100 in use.

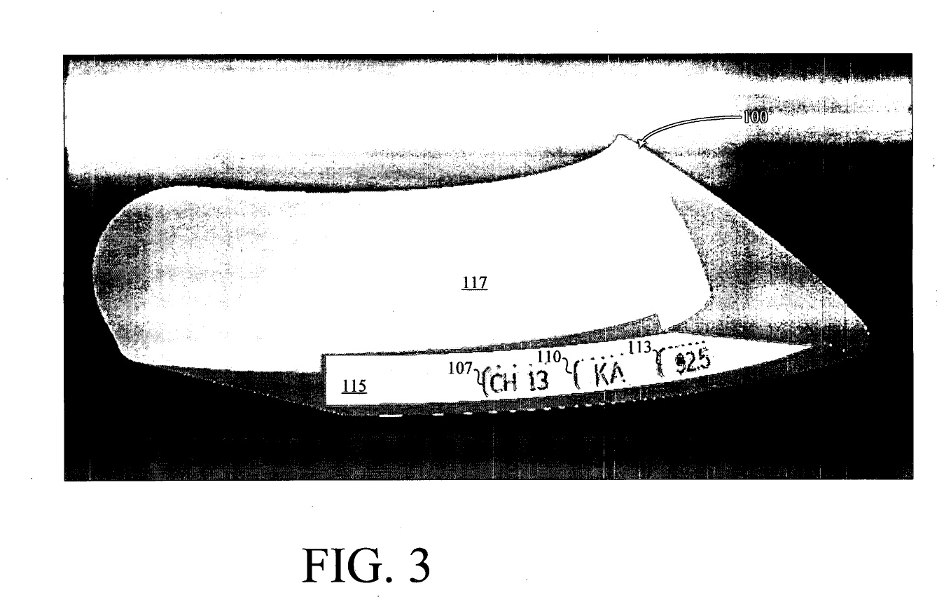

Referring to FIG. 3, the enunciator LEDs, 107, 111, and 113 are evident in the recess 1 15. Also evident is the mounting surface 117 of the housing 100 conformed to the motorcycle helmet.

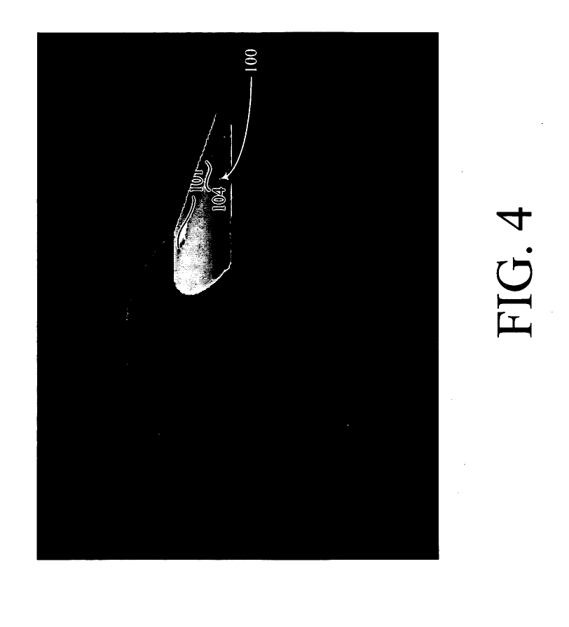

Referring to FIG. 4, the housing 100 is attached to the motorcycle helmet 99 by means of fasteners (not shown) in the recesses 101. The upper surface 104 of the housing 100 is also evident.

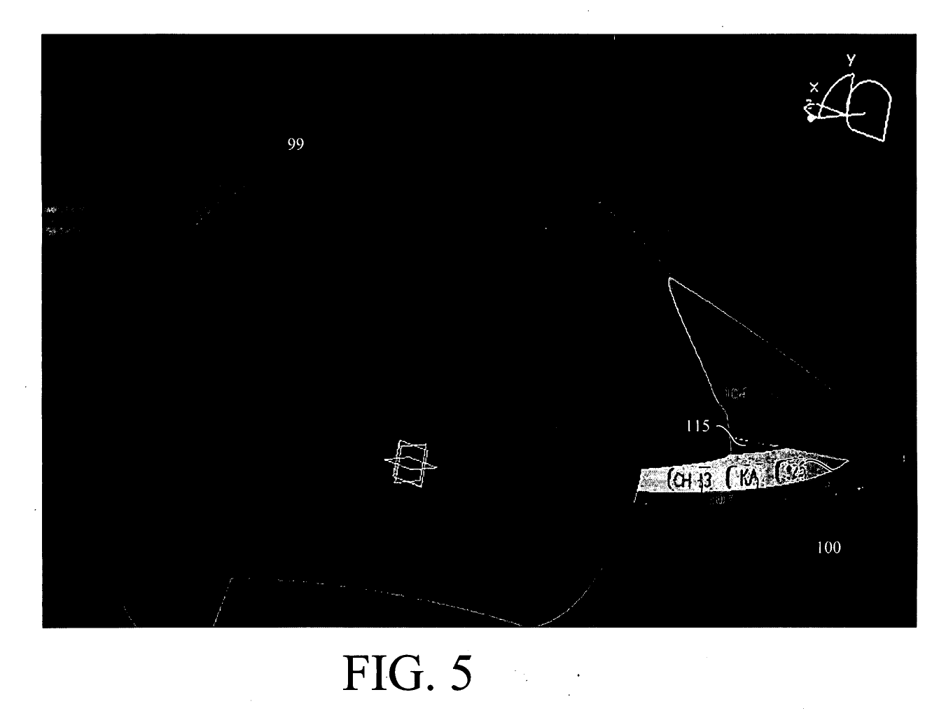

Referring to FIG. 5, the enunciator LEDs, 107, 111, and 113 are evident in the recess 115 as the housing 100 is mounted on the helmet 99. Also evident is the mounting surface 1 17 of the housing 100 conformed to the motorcycle helmet, as is the upper surface.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A radar detection device comprising:
a housing configured to attach to a motorcycle helmet to shield eyes of a motorcycle helmet wearer from overhead sunshine and defining a void; and
a radar detection circuit, the circuit configured to reside in the void and including:
an antenna, the antenna configured to receive an electromagnetic signal, the electromagnetic signal being one of the group consisting of radar signals having wavelengths in the X-band, K-band and Ka-Band and lidar signals and to generate an operative signal based upon receipt of the electromagnetic signal; and
a processor, the processor configured to receive the operative signal from the antenna according to the electromagnetic signal received at the antenna.

2. The radar detection device of claim 1, wherein
the processor is further configured to generate warning signal in response to receiving the operative signal from the antenna.

3. The radar detection device of claim 2 further including:
an enunciator, the enunciator configured to generate an enunciator signal in response to the warning signal.

4. The radar detection device of claim 2, wherein the warning signal is based upon:
which electromagnetic signal from the group consisting of radar signals wavelengths in the X-band, K-band and Ka-Band and lidar signals caused the antenna to generate the operative signal.

5. The radar detection device of claim 2 further including:
an enunciator, the enunciator configured to generate an enunciator signal based upon:
which electromagnetic signal from the group consisting of radar signals wavelengths in the X-band, K-band and Ka-Band and lidar signals caused the antenna to generate the operative signal.

6. The radar detection device of claim 1 further including:
a communication circuit configured to enable communication over an electromagnetic communication link.

7. The radar detection device of claim 1, wherein the electromagnetic link is a Citizens' Band link.

8. The radar detection device of claim 1, wherein the electromagnetic link is a cellular telephone link.

9. The radar detection device of claim 1, wherein the housing is detachably attached to the motorcycle helmet.

10. A radar detection device container comprising:
a housing configured to attach to a motorcycle helmet to shield eyes of a motorcycle helmet wearer from overhead sunshine and defining a void, the void being configured to contain a commercially available radar detection device in an operative position; and
a control interface configured to allow the motorcycle helmet wearer to control the commercially available radar detection device when the housing is attached to the motorcycle helmet.

11. The radar detection device container of claim 10 further including:
a communication circuit configured to enable communication over an electromagnetic communication link.

12. The radar detection device of claim 11, wherein the electromagnetic link is a Citizens' Band link.

13. The radar detection device of claim 11, wherein the electromagnetic link is a cellular telephone link.

14. The radar detection device of claim 10, wherein the housing is detachably attached to the motorcycle helmet.

15. A method for detecting a radar signal, the method includes:
receiving an electromagnetic signal at an antenna, the electromagnetic signal being one of the group consisting of radar signals having wavelengths in the X-band, K-band and Ka-Band and lidar signals and to generate an operative signal based upon receipt of the electromagnetic signal and the antenna being housed by a housing configured to attach to a motorcycle helmet to shield eyes of a motorcycle helmet wearer from overhead sunshine;
generating an operative signal based upon receipt of the electromagnetic signal;
receiving the operative signal at a processor from the antenna according to the electromagnetic signal received at the antenna.

16. The method of claim 15, further comprising:
generating warning signal at the processor in response to receiving the operative signal from the antenna.

17. The method of claim 16 further comprising:
generating an enunciator signal based upon the warning signal received at the enunciator.

18. The method of claim 17, wherein the enunciator signal is based upon which of the electromagnetic signals from the group consisting of radar signals having wavelengths in the X-band, K-band and Ka-Band and lidar signals is received at the antenna.

19. The method of claim 1 further including generating an electromagnetic link.

20. The method of claim 19, wherein the electromagnetic link is a Citizen's band link.
